(19) United States
(12) Patent Application Publication
(10) Pub. No.: US 2013/0067545 A1
(43) Pub. Date: Mar. 14, 2013

(54) Website Security

(71) Applicant: Justin Hanes, San Diego, CA (US)

(72) Inventor: Justin Hanes, San Diego, CA (US)

(73) Assignee: Sony Computer Entertainment America LLC, Foster City, CA (US)

(21) Appl. No.: 13/231,838

(22) Filed: Sep. 13, 2011

(51) Int. Cl. H04L 9/32; G06F 21/20

(52) U.S. Cl. 726/6

(57) ABSTRACT

A system and method for employing fingerprints for user authentication on a website is described. Embodiments of the invention employ a fingerprint scanner integrated into a USB device to scan a current user's fingerprint, and compare it against a stored fingerprint associated with the authorized user. If the current user is determined to be the authorized user, a user name and password associated with a requested website and stored on the USB device is entered onto the website. In one embodiment, the USB device is a password bank that both generates and stores passwords for various websites, removing the need for user memorization altogether.

### FIELD

The present disclosure relates generally to website security, and more particularly, to systems and methods for employing fingerprints for user authentication on a website.

### BACKGROUND

In the past decade, the internet has developed universal appeal as a primary source of information, entertainment, communication and retail. Individuals and businesses alike create, update and refine websites to facilitate end-user access to a wide range of services, ranging from online banking to virtual reality gaming, and from shopping to file sharing. Across each of these mediums, website operators implement user identification systems to perform such functions as storing user names, demographic information, browsing history, preferences and customizations. On certain websites, even more confidential information may be stored, such as credit card numbers, social security numbers, and medical history. Although this information is essential to enhancing and maximizing the user experience on a website, it also poses privacy and security concerns for the end user who shares this information.

Conventional user identification systems implemented on websites require submission of a user name and associated password as proof of identity of a particular user. Such systems act as barriers, blocking access to particular resources and user-specific customizations if the user cannot be verified. To maintain confidentiality of user information, both website operators and users must keep user passwords secret from other users that should not be allowed access. As a further level of security, many websites encourage, or even require, that passwords be a certain length and contain a combination of numbers, special characters and capital and lowercase letters, that would be difficult for an unauthorized user to ascertain. Further, users are encouraged or required to change their passwords on a regular basis, in some cases as often as once a month, and to use different passwords across various websites.

Although implemented to protect the security and privacy of a user, such password-based systems often act as barriers to the user himself, who may not be able to memorize numerous, lengthy strings of characters in conjunction with user names and websites. This may, in effect, subvert the intended high-level of security and in fact reduce it, as users are more likely to write their password down, save it to their browser to “auto complete” on each load of a particular website, to reuse a certain password across various websites and over longer periods of time, or to frequently reset the password. Further, the required use of numbers and special characters in a password provides only minimal protection over sophisticated hackers, who can ascertain a user's easy-to-remember substitutions almost as easily as the original letter, e.g., the replacement of “a” with “@”, “s” with “$”, “I” with “!” or “1”, “E” with “3”, “B” with “8”, and so on.

### SUMMARY

Thus, there is a continuous and ongoing need for novel and improved website security schemes that provide additional layers of protection against password theft, without requiring user memorization of incomprehensible codes. Embodiments of the invention meet this need and others by providing a system and method for employing user fingerprints for user authentication on a website.

According to an embodiment of the invention, a method for employing fingerprints for user authentication on a website is described. The method comprises identifying an accessed website, scanning an input fingerprint associated with a current user, comparing the input fingerprint to a registered fingerprint associated with an authorized user, comparing attributes of the accessed website to stored attributes of one or more websites if the input fingerprint matches the registered fingerprint, retrieving a stored password associated with the accessed website if the attributes of the accessed website match stored attributes of one or more stored websites, generating and storing a new password in association with the accessed website if attributes of the accessed website do not match stored attributes of at least one of the one or more websites, and entering the stored password or the new password on the accessed website.

A computer readable medium having computer executable instructions embedded thereon for performing the steps of this method are described herein. For example, a computer readable medium having computer executable instructions embedded thereon is described that performs the steps of identifying an accessed website, capturing an input fingerprint associated with a current user, comparing the input fingerprint to a registered fingerprint associated with an authorized user, comparing attributes of the accessed website to stored attributes of one or more websites if the input fingerprint matches the registered fingerprint, retrieving a stored password associated with the accessed website and entering the stored password on the accessed website if the attributes of the accessed website match stored attributes of one or more websites, and generating a new password, storing the new password in association with the accessed website, and entering the new password on the accessed website if attributes of the accessed website do not match stored attributes of at least one of the one or more websites. The computer readable medium can be a USB device or a flash drive incorporating a fingerprint sensor according to an embodiment.

Systems for effecting this method are also described herein according to embodiments of the invention. For example, a system for employing fingerprints for user authentication on a website is described. The system comprises a computing device operable to load a requested website, an input device operable to scan an input fingerprint associated with a current user, a processor, and a memory coupled to the processor. The processor is operable to identify the requested website, compare the input fingerprint to a registered fingerprint associated with an authorized user, compare attributes of the requested website to stored attributes of one or more websites if the input fingerprint matches the registered fingerprint, retrieve a stored password associated with the requested website if the attributes of the requested website match stored attributes of one or more websites, generate a new password if attributes of the requested website do not match stored attributes of at least one of the one or more stored websites, and enter the stored password or the new password on the requested website. The memory stores the new password in association with the requested website.

Another embodiment of a system for employing fingerprints for user authentication on a website is also described. The system comprises an identification module operable to identify an accessed website, an input module operable to capture an input fingerprint associated with a current user, a fingerprint comparison module operable to compare the input fingerprint to a registered fingerprint associated with an authorized user, an attribute comparison module operable to compare attributes of the accessed website to stored attributes of one or more websites if the input fingerprint matches the registered fingerprint, a retrieval module operable to retrieve a stored password associated with the accessed website if the attributes of the accessed website match stored attributes of one or more websites, a generation module operable to generate a new password and store the new password in association with the accessed website if the attributes of the accessed website do not match the stored attributes of at least one of the one or more websites, and an entry module operable to enter at least one of the stored password and the new password on the accessed website.

### BRIEF DESCRIPTION OF THE DRAWINGS

FIG. 1 is a flowchart illustrating the steps of a method for employing fingerprints for user authentication on a website.

FIG. 2A is a flowchart illustrating the steps of a method for generating and storing a password in conjunction with a fingerprint for user authentication on a website according to an embodiment of the invention.

FIG. 2B is a flowchart illustrating the steps of a method for generating and storing a password in conjunction with a fingerprint for user authentication on a website according to another embodiment of the invention.

FIG. 3 is a flowchart illustrating the steps of a combined method for employing fingerprints and generating passwords for user authentication on a website.

FIG. 4 is a schematic diagram illustrating a system of an embodiment for effecting the methods described herein.

FIG. 5 is a schematic diagram illustrating modules of a system of an embodiment for effecting the methods described herein.

FIG. 6 is diagrammatic representation of a machine having a set of instructions for causing the machine to perform any of the one or more methods described herein.

### DETAILED DESCRIPTION

A system and method for employing user fingerprints for user authentication on a website is described. In the following description, for purposes of explanation, numerous specific details are set forth in order to provide a thorough understanding of the exemplary embodiments. It is apparent to one skilled in the art, however, that embodiments of the present invention can be practiced without these specific details or with an equivalent arrangement. In some instances, well-known structures and devices are shown in block diagram form in order to avoid unnecessarily obscuring the embodiments.

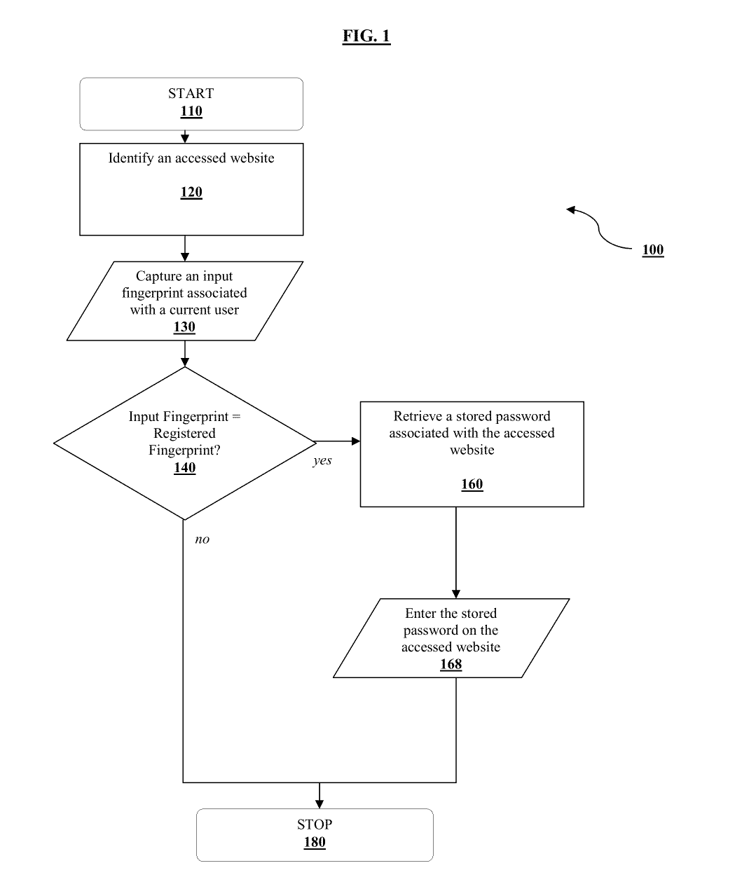

Referring now to the drawings, wherein like reference numerals designate identical or corresponding parts throughout the several views, FIG. 1 is a flowchart 100 illustrating a method for employing fingerprints for user authentication on a website by identifying a known user having a known password according to an embodiment of the invention. The method begins at start block 110. At processing block 120, an accessed website is identified. The website can be accessed by a user directly, such as by typing in a URL address, or indirectly, such as by clicking a link or selecting a pop-up window. The website can be identified by extracting an identifier, such as a URL address or IP address.

At I/O block 130, an input fingerprint associated with a current user is captured. In one embodiment, the input fingerprint is scanned. Optionally, the input fingerprint can be analyzed to determine whether the captured data is adequate for fingerprint authentication. For example, the input fingerprint can be analyzed to determine if sufficient ridges were captured to enable identification of patterns in the fingerprint. Insufficient ridge pattern can be caused by, for example, insufficient contact of the finger to the touch sensor, or a scratched or dirty touch sensor. An inadequate fingerprint capture can also be caused by improper alignment or orientation. If the input fingerprint is inadequate for fingerprint authentication, I/O block 130 can be repeated, and the input fingerprint can again be scanned.

At decision block 140, the input fingerprint is compared to a registered fingerprint. The entire input fingerprint can be compared to an entire registered fingerprint; features within the input fingerprint can be compared to an entire registered fingerprint, or vice versa; or features within the input fingerprint can be compared to features within the registered fingerprint. In the case of feature identification, the input fingerprint or its biometric template can be analyzed against a biometric template of the registered fingerprint. The biometric template, which represents a collection of extracted features or data points, consists of unique, identified ridge patterns and minutia features in the registered fingerprint, such as arcs, loops, whorls, ridge endings, bifurcations and dots. The input fingerprint or its biometric template is graphically compared against the biometric template of the registered fingerprint to determine whether a threshold number of similarities (e.g., features or data points in common) exist between the input fingerprint and the registered fingerprint.

If the input fingerprint does not have a threshold number of similarities with the registered fingerprint, then the method ends at stop block 180. If the input fingerprint has a threshold number of similarities with the registered fingerprint, then the method continues at processing block 160. At processing block 160, a stored password associated with the accessed website is retrieved. At I/O block 168, the stored password is entered on the accessed website, and the method ends at stop block 180.

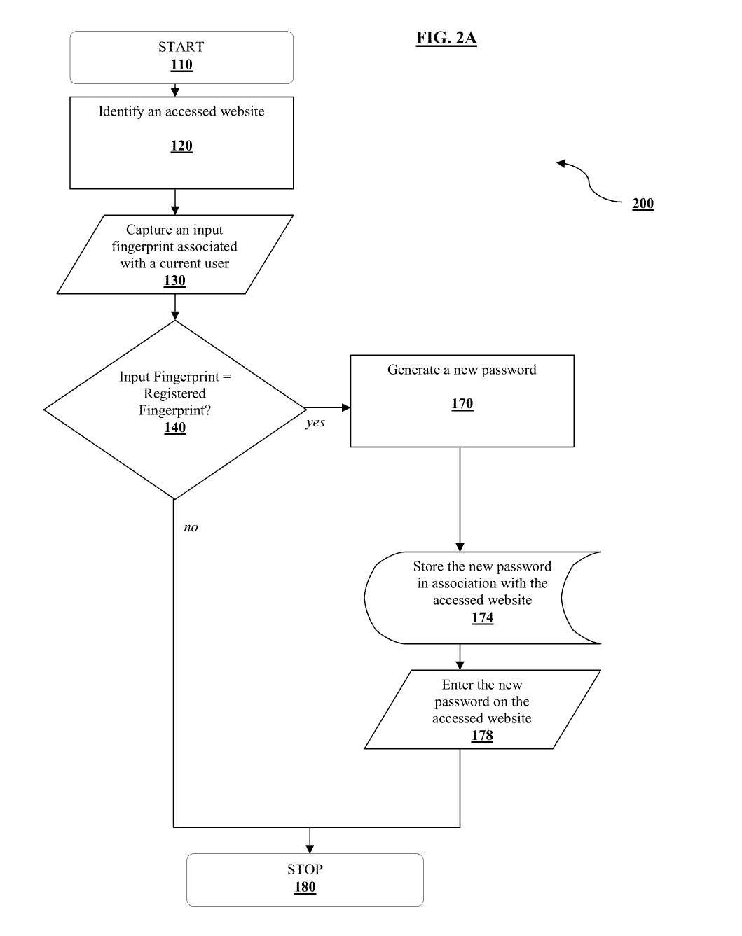

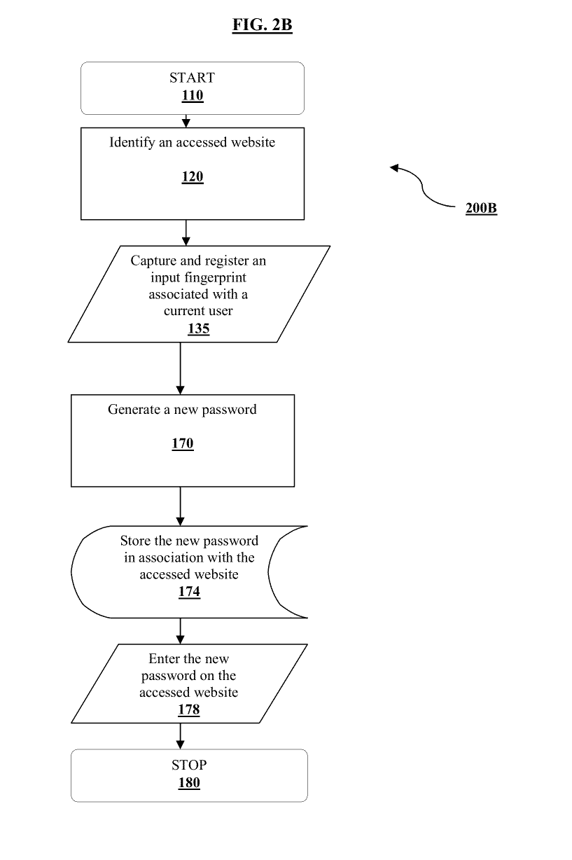

FIG. 2A is a flowchart 200A illustrating a method for employing fingerprints for user authentication on a website by generating and storing a new password in conjunction with a known fingerprint according to an embodiment of the invention.

The method begins at start block 110. At processing block 120, an accessed website is identified. Again, the website can be accessed by a user directly, such as by typing in a URL address, or indirectly, such as by clicking a link or selecting a pop-up window. The website can be identified, for example, by extracting its URL address, IP address, or other identifier.

At I/O block 130, an input fingerprint associated with a current user is captured, and at decision block 140, the input fingerprint is compared to a registered fingerprint. If the input fingerprint does not have a threshold number of similarities with the registered fingerprint, then the method ends at stop block 180. If the input fingerprint has a threshold number of similarities with the registered fingerprint, then the method continues at processing block 170, where a new password is generated. In this embodiment, the new password is automatically generated, independent of the user. In order to maximize security, the generated password can contain a random set of letters, numbers, symbols, capital letters, and combinations thereof that meet the requirements of the accessed website. Further, the generated password can be different from all other stored passwords to provide an additional layer of security. In this embodiment, if one password is hacked or otherwise obtained without permission, all other accounts with different passwords can remain secure.

The new password can be associated with a newly accessed website, or can replace a previous password associated with a previously accessed website. In the latter example, the password for a previously accessed website can be updated periodically, e.g., weekly, monthly or yearly, can be updated upon request of the accessed website, or can be updated upon request of the user.

At storage block 174, the new password is stored in association with the accessed website and the registered fingerprint, and the new password is entered on the accessed website at I/O block 178. Thus, the new password can be entered automatically on the accessed website in the future by scanning the registered fingerprint, without the need for the user to memorize the password.

In another embodiment, a new password can be created and entered on the accessed website by the user. In this embodiment, the new password is obtained for storage directly from the user or indirectly by extraction from the user entry on the accessed website. The new password is stored in association with the accessed website and the registered fingerprint, and the method ends at stop block 180.

FIG. 2B is a flowchart 200B illustrating a method for employing fingerprints for user authentication on a website by generating and storing a new password in conjunction with a new fingerprint according to another embodiment of the invention. The method begins at start block 110. At processing block 120, an accessed website is identified, such as by one of the methods described above.

At I/O block 135, one or more input fingerprints associated with a current user are captured and registered. The input fingerprint is registered when the captured fingerprint is stored. The captured fingerprint can be stored in full (e.g., as an entire image), can be converted into another data type, and/or can be stored as a collection of identifiers, such as in a biometric template. The biometric template, which represents a collection of extracted features or data points, consists of unique, identified ridge patterns and minutia features in the registered fingerprint, such as arcs, loops, whorls, ridge endings, bifurcations and dots.

A new password is generated at processing block 170, such as by the methods described above. At storage block 174, the new password is stored in association with the accessed website and the newly registered fingerprint(s), and the new password is entered on the accessed website at I/O block 178. In another embodiment, a new password can be created and entered on the accessed website by the user. In this embodiment, the new password is obtained for storage either directly from the user or indirectly by extraction from the user entry on the accessed website. The new password can then be stored in association with the accessed website and the registered fingerprint. The method ends at stop block 180.

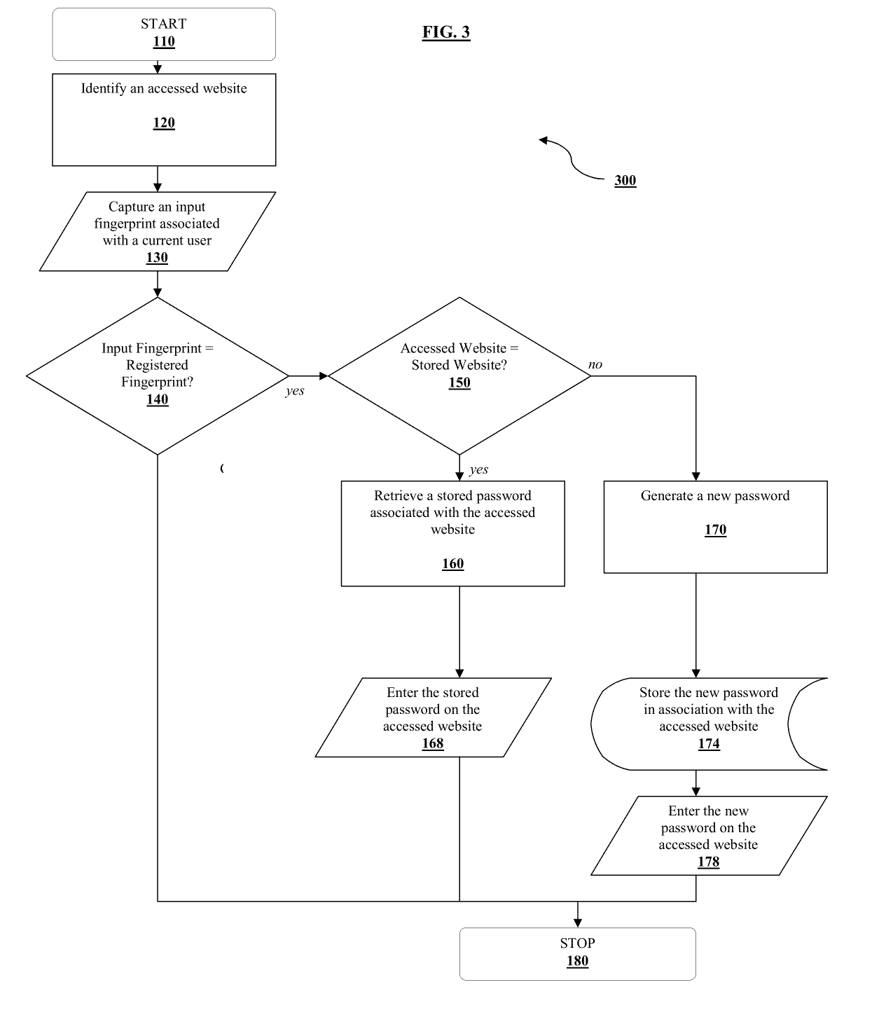

FIG. 3 is a flowchart 300 illustrating a combined method for employing fingerprints for user authentication on a website that can be used to both retrieve stored passwords for known websites and generate new passwords for new websites according to an embodiment of the invention. The method begins at start block 110. At processing block 120, an accessed website is identified. The website can be accessed by a user directly, such as by typing in a URL address, or indirectly, such as by clicking a link or selecting a pop-up window. Again, the website can be identified by extracting an identifier, such as a URL address, IP address, or the like.

At I/O block 130, an input fingerprint associated with a current user is captured. In one embodiment, the input fingerprint is captured by scanning Optionally, the input fingerprint can be analyzed to determine whether the captured data is adequate for fingerprint authentication, as discussed above. If the input fingerprint is inadequate for fingerprint authentication, I/O block 130 can be repeated, and the input fingerprint can again be scanned.

At decision block 140, the input fingerprint is compared to a registered fingerprint. The entire input fingerprint can be compared to an entire registered fingerprint; features within the input fingerprint can be compared to an entire registered fingerprint, or vice versa; or features within the input fingerprint can be compared to features within the registered fingerprint, as discussed above. If the input fingerprint does not have a threshold number of similarities (i.e., features or data points in common) with the registered fingerprint, then the method ends at stop block 180. If the input fingerprint has a threshold number of similarities with the registered fingerprint, then the method continues at decision block 150.

At decision block 150, one or more attributes of the accessed website are compared to one or more stored attributes of one or more websites. Attributes can include URL addresses, IP addresses, hosts, source or other codes, protocols, types, encryptions, sizes, creation dates, modification dates, titles, images, fonts, font sizes, headlines, body content, embedded content, multimedia (e.g., graphics, audio, video), frames, positions, formats, alignments, hyperlinks, text, copyright information, policies, credits, layouts, scripts, and combinations thereof. For example, the extracted identifier associated with the accessed website can be compared to one or more stored identifiers associated with the one or more websites to determine whether the accessed website is a known website. In an example combining attributes, the layout and title of the accessed website can be analyzed against the layouts and titles of the stored websites. In still another embodiment, all attainable attributes of the accessed website can be compared against all stored attributes of one or more website, for example, by making a full graphical comparison of the websites.

If the attributes of the accessed website match stored attributes of one or more websites, then the method continues at processing block 160, where a stored password associated with the accessed website is retrieved. In an embodiments where a family of websites share a single log-in (i.e., a network of websites allowing a user to log on to all websites within the network using a single user name and password), attributes of the accessed website in common with stored attributes of any of the websites within the family can be used to retrieve a password stored in conjunction with any of the websites within the family, even if it is not stored in conjunction with the accessed website. Further, in another embodiment relating to a family of websites, a new or stored password associated with an accessed website can be stored in conjunction with all websites known to be within the accessed website's family of websites.

Turning back to FIG. 3, at I/O block 168, the stored password is entered on the accessed website if the attributes of the accessed website match stored attributes of one or more websites, and the method ends at stop block 180. If the attributes of the accessed website do not match stored attributes of at least one of the one or more websites, then the method continues at processing block 170, where a new password is automatically generated. At storage block 174, the new password is stored in association with the accessed website and the registered fingerprint, and the new password is entered on the accessed website at I/O block 178. In another embodiment, a new password can be created, entered and stored directly by the user, or alternatively, can be created and entered on the accessed website by the user, then obtained indirectly for storage by extraction, for example. The method ends at stop block 180.

Although described primarily with respect to passwords, both the user name and password for various websites can be stored and accessed by means of fingerprint authentication. Accordingly, any other information required or desirable for website access can also be stored and accessed by means of fingerprint authentication, such as demographic information, credit card information, and the like.

Further, although illustrated and described with respect to a single input fingerprint and a single registered fingerprint, the methods herein described can be similarly applied to multiple input fingerprints and/or multiple registered fingerprints. For example, in the case where a website is accessed from a shared computer, multiple fingerprints may be registered and associated with different user names and passwords for the same website, and the appropriate password can be retrieved and entered upon confirmation of its associated fingerprint. In another example, multiple fingerprints (from either a single user or multiple users) may be registered and associated with the same user name and password for the same website, and password entry is performed after confirmation of any of the registered fingerprints.

Still further, multiple fingerprints may be registered and associated with the same user name, but must all be scanned and verified prior to entry of the password. This embodiment can be used to require multiple fingerprints of a single user, for example, to provide an additional layer of security and to decrease the risk of unauthorized access. Alternatively, this embodiment can be used to require one or more fingerprints of multiple users to prevent access by one user where permission of multiple users is required. For example, logging into an online joint bank account (or to perform particular actions within an online joint bank account) could require the verification of both owners of the bank account, even if only a single user name and password is associated with that account. Thus, functions within the online joint bank account, such as transferring money in and out of the account, can be limited when both owners are not present.

The methods herein described can be performed transparent to the accessed website, such that accessed websites do not need any particular code to be used in conjunction with embodiments of the invention. In other embodiments, however, the methods described herein can be performed in combination with the accessed website. For example, the accessed website may push website identification information, such that website identifiers need not be extracted.

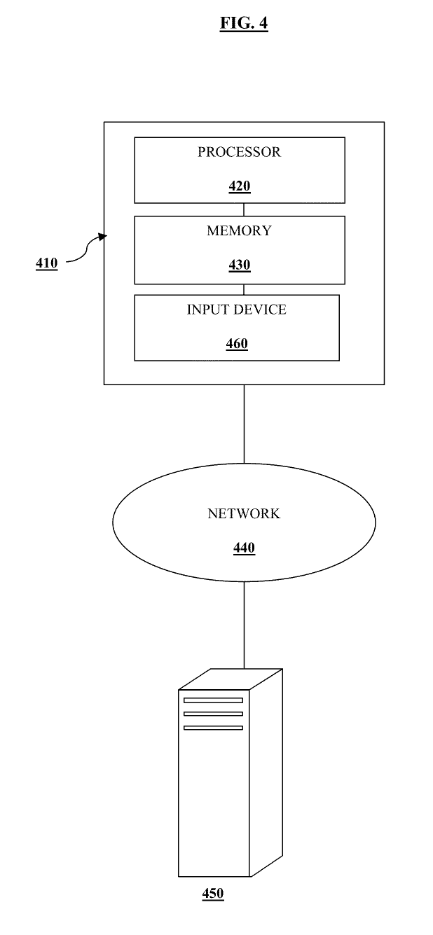

FIG. 4 illustrates a system for fingerprint authentication comprising computing device 410 that is connected over network 440 to a server 450. In this embodiment, computing device 410 includes processor 420, memory 430 and input device 460 (e.g., a fingerprint sensor or scanner), which are in communication with one another. Input device 460, processor 420 and/or memory 430 can either be incorporated into a USB device or flash drive connected to computing device 410, or can be incorporated into computing device 410, or combinations thereof. When comprised in a USB device or flash drive, auto-run software associated with input device 460 and loaded in memory 430 can be employed to begin performing the methods discussed herein.

Input device 460 scans or senses an input fingerprint of a current user and transmits the fingerprint data captured by the scan to processor 420. Processor 420 determines whether the captured fingerprint data is adequate for fingerprint authentication as discussed further above, and either registers the fingerprint data in memory 430 or compares the fingerprint data to registered fingerprint data stored in memory 430, or both.

Memory 430 may be any type of storage media that may be volatile or non-volatile memory that includes, for example, read-only memory (ROM), random access memory (RAM), magnetic disk storage media, optical storage media, flash memory devices, and zip drives. Memory 430 provides the registered fingerprint data to processor 420 and registers new input fingerprint data. New fingerprint data can be stored in association with an existing user profile, such as to store multiple fingerprints of a single user in conjunction with that user. Alternatively, new fingerprint data can be stored in association with a new user profile. Further, the fingerprint data can be stored as a direct copy of the user fingerprint, can be converted into a biometric template or other set of unique identifiers, or both.

Input device 460 can employ one or more of various technologies to capture a user's fingerprint pattern. For example, input device 460 can be a digital camera, i.e., can use optical fingerprint imaging to capture a digital image using visible light. In this embodiment, input device 460 comprises a touch surface where the finger is placed, which is positioned over a light source. The light source emits light onto the surface of the finger, which, in turn, reflects light onto an image sensor, such as a CCD (charge coupled device) or CMOS (complimentary metal oxide semiconductor) element. Because the intensity of the reflected light is different in a ridge of a fingerprint versus in a valley of a fingerprint, the image sensor is able to obtain an image of a fingerprint based on the difference between the reflected light intensities.

In another embodiment, input device 460 can be an ultrasonic sensor using high frequency sound waves to penetrate the derma, or sub-surface of the skin, as opposed to the epidermal skin. In this embodiment, ultrasonic vibrations are generated by piezoelectric transducers and reflected energy is measured by an array of piezoelectric pillars. In general, reflected energy corresponding to a fingerprint ridge is very low, and reflected energy corresponding to a valley is very high. By arranging the piezoelectric pillars into a grid of numerous elements, an image of the fingerprint can be created.

In still other embodiments, input device 460 can be an electro-optical reader, a capacitance sensor (using either passive or active capacitance), a pressure sensor, a thermal sensor, a phototonic crystal sensor, an RF field sensor, an optical touchless sensor, a contact sensor, a static electricity sensor, and the like.

Computing device 410 may be mainframes, minicomputers, personal computers, laptops, personal digital assistants (PDAs), cell phones, televisions, DVD players, BD players, game consoles, and the like. Computing device 410 is characterized in that it is capable of being connected to network 440. Network 440 may be a local area network (LAN), wide area network (WAN), a telephone network, such as the Public Switched Telephone Network (PSTN), an intranet, the Internet, or combinations thereof.

Computing device 410 is configured to request a website from server 450, and server 450 is configured to provide the requested website to computing device 410. Server 450 is typically a computer system, and may be an HTTP (Hypertext Transfer Protocol) server, such as an Apache server, and may itself include a processor and memory (not shown).

In implementing the method illustrated in FIG. 1, for example, a user of computing device 410 enters a URL corresponding to a desired website in an internet browser. Computing device 410 communicates a request to access and display the desired website to server 450 over network 440. For example, a signal is transmitted from computing device 410, the signal having a destination address (e.g., an address representing a server), a request (e.g., a request for a website associated with a particular URL), and a return address (e.g., an address representing computing device 410, which initiated the request). Server 450 locates the website associated the requested URL, and communicates data representing the website to the user over network 440. For example, another signal may be transmitted that includes a destination address corresponding to the return address of the computing device, and the website responsive to the request.

Computing device 410 loads the requested website, and processor 420 determines whether user identification information, i.e., a user name and password, are needed to access further content on the website. If user identification information is required, processor 420 sends a request to input device 460 for an input fingerprint associated with the user requesting the website. Input device 460 captures the input fingerprint and returns it to computing device 410, where it is stored in memory 430.

Optionally, the input fingerprint can be analyzed by processor 420 to determine whether the input fingerprint is adequate for fingerprint authentication. Processor 420 can determine the quality of the input fingerprint by employing, for example, a characterization algorithm, which determines the usability of the print based on various factors (e.g., sufficient ridge detail). Processor 420 can further employ a characterization algorithm to perform image processing. For example, processor 420 can improve the quality of the input fingerprint (e.g., by eliminating noise, adding or removing contrast, reconstructing ridges, and extracting minutiae), separate and identify the ridges and valleys of the input fingerprint, derive the character points and special points of the input fingerprint, and change and convert the input fingerprint into one or more other formats suitable for comparison (e.g., through binarization and thinning).

In one embodiment, processor 420 constantly runs in the background of computing device 410 in order to scan requested websites to determine which websites are being accessed and whether user identification information is required. Determination of accessed websites can be performed by a plug-in on the internet browser requesting the website.

Processor 420 compares the input fingerprint to a registered fingerprint associated with an authorized user of computing device 410. Processor 420 performs this comparison by using one or more of a variety of algorithms for fingerprint recognition, such as a minutiae matching algorithm or a direct image-based algorithm. With respect to a direct image-based algorithm, the input fingerprint image is directly compared against the registered fingerprint image. Such an algorithm may center and rotate the input fingerprint image as necessary, identify arches, whorls and loops in the input fingerprint, and look for similar arches, whorls and loops in the registered fingerprint image. Once centered and adjusted, the comparison can alternatively be performed by overlaying the input fingerprint image onto the registered fingerprint image and determining the degree to which the fingerprints match.

In another embodiment, processor 420 can employ a minutiae matching algorithm to compare the identified character points within the input fingerprint to identified character points within the registered fingerprint, and to calculate the degree of similarity between the two fingerprints. The minutiae matching algorithm may first analyze the geometric characteristics (e.g., distance and angle) between two extracted minutiae, creating minutiae pairs within the input fingerprint. Once a sufficient number of minutiae pairs are identified, a local similarity measurement can be performed to find similar minutiae pairs in the registered fingerprint, if any. A global similarity measurement can then be performed by selecting the greatest matching minutiae pairs between the input fingerprint and the registered fingerprint. Using the global similarity measurement, final matching scores between the input fingerprint and the registered fingerprint can be calculated, and compared against an established critical value needed to verify that the current user is the registered user.

Regardless of the algorithm used to analyze the fingerprints, the processor compares attributes of the requested website to stored attributes of one or more websites in memory 430 if the fingerprints are found to be sufficiently similar. If the attributes of the requested website match stored attributes of one or more websites in memory 430, a password stored in memory 430 in association with the stored website and the registered fingerprint is entered onto the requested website.

If the attributes of the requested website do not match stored attributes of at least one of the one or more websites in memory 430, processor 420 automatically generates a new password, stores the new password in memory 430 in association with the requested website, and enters the new password onto the website. In another embodiment, if the requested website does not match one or more stored websites in memory 430, the user of computing device 410 enters a password on the requested website. Processor 420 then extracts the entered password from the requested website, and stores the new password in memory 430 in association with the requested website.

Although described with respect to the method illustrated in FIG. 3, it is understood that any of the methods described herein can be similarly performed. Further, although described with particular devices, it is understood that a variety of similar devices may be employed to perform the processes described herein. The functions of these and other embodiments can be described as modules of computer executable instructions recorded on tangible media. The modules can be segregated in various manners over various devices.

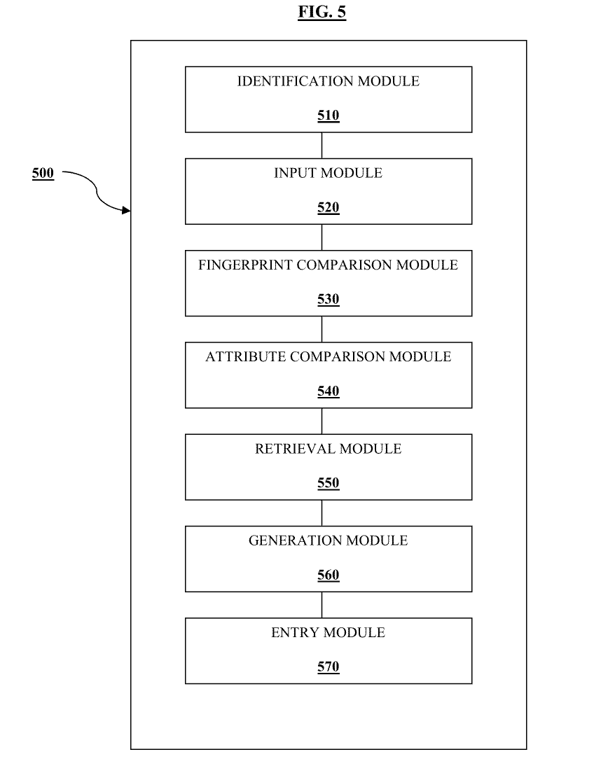

For example, FIG. 5 illustrates a system 500 for employing fingerprints for user authentication on a website using modules according to an embodiment. The system comprises an identification module 510, an input module 520, a fingerprint comparison module 530, an attribute comparison module 540, a retrieval module 550, a generation module 560, and an entry module 570. Identification module 510 identifies an accessed website, and input module 520 captures an input fingerprint associated with a current user. Fingerprint comparison module 530 compares the input fingerprint to a registered fingerprint associated with an authorized user.

If the input fingerprint matches the registered fingerprint, attribute comparison module 540 compares attributes of the accessed website to stored attributes of one or more websites. If the attributes of the accessed website match stored attributes of one or more websites, retrieval module 550 retrieves a stored password associated with the accessed website. If the attributes of the accessed website do not match the stored attributes of at least one of the one or more websites, generation module 560 generates a new password and stores the new password in association with the accessed website. Entry module 570 enters either the stored password or the new password on the accessed website, depending on whether or not the attributes of the accessed website match stored attributes of one or more websites.

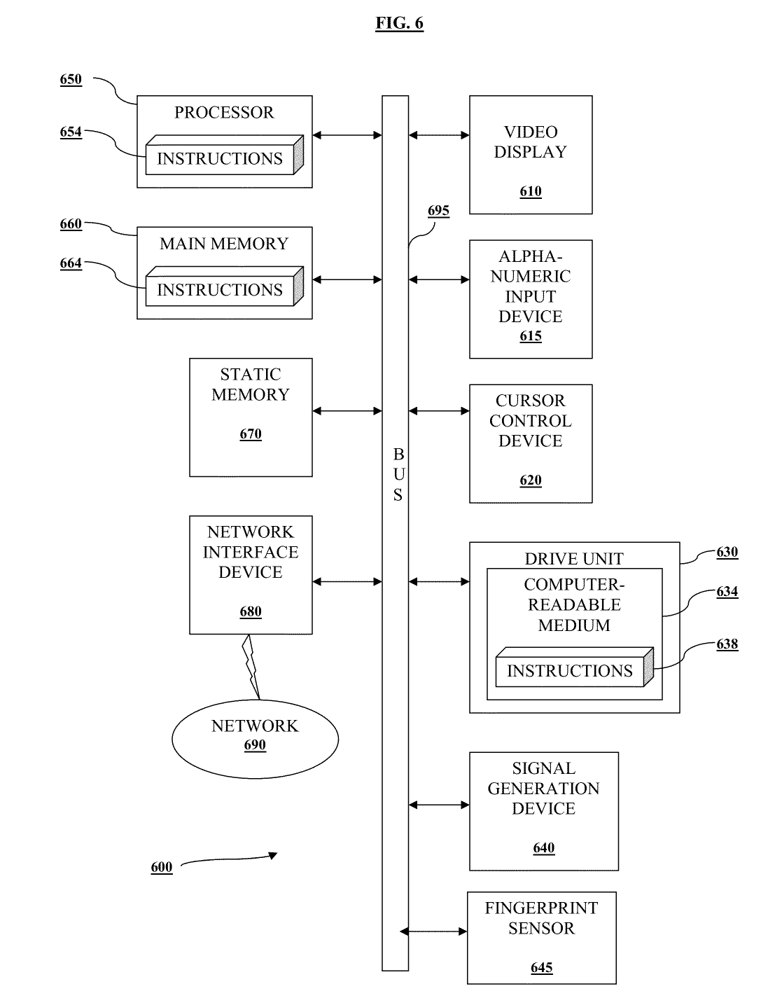

FIG. 6 shows a diagrammatic representation of machine in the exemplary form of computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, a game console, a television, a CD player, a DVD player, a BD player, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

According to some embodiments, computer system 600 comprises processor 650 (e.g., a central processing unit (CPU), a graphics processing unit (GPU) or both), main memory 660 (e.g., read only memory (ROM), flash memory, dynamic random access memory (DRAM) such as synchronous DRAM (SDRAM) or Rambus DRAM (RDRAM), etc.) and/or static memory 670 (e.g., flash memory, static random access memory (SRAM), etc.), which communicate with each other via bus 695.

According to some embodiments, computer system 600 may further comprise video display unit 610 (e.g., a liquid crystal display (LCD) or a cathode ray tube (CRT)) and fingerprint sensor 645 (e.g., contained on a flash drive or USB device). According to some embodiments, computer system 600 also may comprise alphanumeric input device 615 (e.g., a keyboard), cursor control device 620 (e.g., a mouse), disk drive unit 630, signal generation device 640 (e.g., a speaker), and/or network interface device 680.

Disk drive unit 630 includes computer-readable medium 634 on which is stored one or more sets of instructions (e.g., software 638) embodying any one or more of the methodologies or functions described herein. Software 638 may also reside, completely or at least partially, within main memory 660 and/or within processor 650 during execution thereof by computer system 600, main memory 660 and processor 650 also constituting computer-readable media. Software 638 may further be transmitted or received over network 690 via network interface device 680.

While computer-readable medium 634 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

It should be understood that processes and techniques described herein are not inherently related to any particular apparatus and may be implemented by any suitable combination of components. Further, various types of general purpose devices may be used in accordance with the teachings described herein. It may also prove advantageous to construct a specialized apparatus to perform the methods described herein. Those skilled in the art will appreciate that many different combinations of hardware, software, and firmware will be suitable for practicing the present invention.

The present invention has been described in relation to particular examples, which are intended in all respects to be illustrative rather than restrictive. Further, while the present invention has been described in connection with a number of exemplary embodiments, and implementations, the present inventions are not so limited, but rather cover various modifications, and equivalent arrangements.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A method for employing fingerprints for user authentication on a website, the method comprising:
identifying an accessed website;
capturing an input fingerprint associated with a current user;
comparing the input fingerprint to a registered fingerprint associated with an authorized user;
comparing attributes of the accessed website to stored attributes of one or more websites if the input fingerprint matches the registered fingerprint;
if the attributes of the accessed website match stored attributes of one or more websites, retrieving a stored password associated with the accessed website, and entering the stored password on the accessed website; and
if the attributes of the accessed website do not match stored attributes of at least one of the one or more websites, generating a new password, storing the new password in association with the accessed website, and entering the new password on the accessed website.

2. The method of claim 1, further comprising the steps of:
identifying a plurality of data points within the input fingerprint; and
establishing a biometric template of the input fingerprint using the plurality of data points.

3. The method of claim 2, wherein the step of comparing the input fingerprint to a registered fingerprint further comprises comparing the biometric template of the input fingerprint to a biometric template of the registered fingerprint.

4. The method of claim 1, further comprising the steps of:
if the attributes of the accessed website match stored attributes of at least one of the one or more websites, retrieving a stored user name associated with the accessed website and entering the stored user name on the accessed website; and
if the attributes of the accessed website do not match stored attributes of at least one of the one or more stored websites, generating a new user name, storing the new user name in association with the accessed website, and entering the new user name on the accessed website.

5. The method of claim 1, wherein the new password is generated randomly.

6. The method of claim 1, wherein the new password is different than one or more stored passwords.

7. The method of claim 1, wherein the new password is generated independent from the current user.

8. A system for employing fingerprints for user authentication on a website, the system comprising:
a computing device operable to load a requested website;
an input device operable to capture an input fingerprint associated with a current user;
a processor operable to:
identify the requested website;
compare the input fingerprint to a registered fingerprint associated with an authorized user;
compare attributes of the requested website to stored attributes of one or more websites if the input fingerprint matches the registered fingerprint;
if the attributes of the requested website match stored attributes of one or more websites, retrieve a stored password associated with the requested website, and enter the stored password on the requested website; and
if attributes of the requested website do not match stored attributes of at least one of the one or more websites, generate a new password and enter the new password on the requested website; and
a memory coupled to the processor operable to store the new password in association with the requested website.

9. The system of claim 8, wherein the input device is a fingerprint sensor.

10. The system of claim 9, wherein the fingerprint sensor is comprised in at least one of a USB device and a flash drive.

11. The system of claim 8, wherein the processor is further operable to:
identify a plurality data points within the input fingerprint; and
establish a biometric template of the input fingerprint using the plurality of data points.

12. The system of claim 11, wherein the processor is further operable to compare the input fingerprint to a registered fingerprint by comparing the biometric template of the input fingerprint to a biometric template of the registered fingerprint.

13. The system of claim 8, wherein the processor is further operable to:
if attributes of the requested website match stored attributes of one or more websites, retrieve a stored user name associated with the requested website, and enters the stored user name on the requested website; and
if attributes of the requested website do not match stored attributes of at least one of the one or more websites, generate a new user name, and enter the new user name on the requested website.

14. The system of claim 13, wherein the memory is further operable to store the new user name in association with the accessed website.

15. The system of claim 8, wherein the new password is different than one or more stored passwords.

16. The system of claim 8, wherein the new password is generated independent from the current user.

17. A computer readable medium having computer executable instructions embedded thereon for performing the steps of:
identifying an accessed website;
capturing an input fingerprint associated with a current user;
comparing the input fingerprint to a registered fingerprint associated with an authorized user;
comparing attributes of the accessed website to stored attributes of one or more websites if the input fingerprint matches the registered fingerprint;
if the attributes of the accessed website match stored attributes of one or more websites, retrieving a stored password associated with the accessed website and entering the stored password on the accessed website; and
if attributes of the accessed website do not match stored attributes of at least one of the one or more websites, generating a new password, storing the new password in association with the accessed website, and entering the new password on the accessed website.

18. The computer readable medium of claim 17, wherein the computer readable medium comprises a fingerprint sensor.

19. The computer readable medium of claim 17, wherein the computer readable medium is at least one of a USB device and a flash drive.

20. The computer readable medium of claim 17, wherein the new password is generated randomly.

21. The computer readable medium of claim 17, wherein the new password is different than one or more stored passwords.

22. The computer readable medium of claim 17, wherein the new password is generated independent from the current user.

23. A system for employing fingerprints for user authentication on a website, the system comprising:
an identification module operable to identify an accessed website;
an input module operable to capture an input fingerprint associated with a current user;
a fingerprint comparison module operable to compare the input fingerprint to a registered fingerprint associated with an authorized user;
an attribute comparison module operable to compare attributes of the accessed website to stored attributes of one or more websites if the input fingerprint matches the registered fingerprint;
a retrieval module operable to retrieve a stored password associated with the accessed website if the attributes of the accessed website match stored attributes of one or more websites;
a generation module operable to generate a new password and store the new password in association with the accessed website if the attributes of the accessed website do not match the stored attributes of at least one of the one or more websites; and
an entry module operable to enter at least one of the stored password and the new password on the accessed website.

24. The system of claim 23, wherein the fingerprint comparison module is further operable to identify a plurality of data points within the input fingerprint and establish a biometric template of the input fingerprint using the plurality of data points.

25. The system of claim 24, wherein the fingerprint comparison module is operable to compare the input fingerprint to the registered fingerprint by comparing the biometric template of the input fingerprint to a biometric template of the registered fingerprint.

26. The system of claim 23,
wherein the retrieval module is further operable to retrieve a user name associated with the accessed website if the attributes of the accessed match stored attributes of one or more websites,
wherein the generation module is further operable to generate a new user name and store the new user name in association with the accessed website if the attributes of the accessed website do not match the stored attributes of at least one of the one or more websites; and
wherein the entry module is further operable to enter at least one of the stored user name and the new user name on the accessed website.

27. The system of claim 23, wherein the generation module is operable to generate the new password randomly.

28. The system of claim 23, wherein the generation module is operable to generate the new password such that it is different than one or more stored passwords.

29. The system of claim 23, wherein the generation module is operable to generate the new password independent from the current user.
